(19) United States
(12) Patent Application Publication
(10) Pub. No.: US 2018/0018315 A1
(43) Pub. Date: Jan. 18, 2018

(54) INFORMATION PROCESSING DEVICE, PROGRAM, AND INFORMATION PROCESSING METHOD

(71) Applicant: Retrieva, Inc., Tokyo (JP)

(72) Inventors: Yuya Takei, Tokyo (JP); Yuichiro Imamura, Tokyo (JP); Hideto Masuoka, Tokyo (JP); Jiro Nishitoba, Tokyo (JP); Kazuya Kawahara, Tokyo (JP)

(73) Assignee: Retrieva, Inc., Tokyo (JP)

(21) Appl. No.: 15/647,162

(22) Filed: Jul. 11, 2017

(30) Foreign Application Priority Data
Jul. 14, 2016 (JP) 2016-139740

(51) Int. Cl. G06F 17/27; G06F 17/21; G06F 3/0482

(52) U.S. Cl. CPC G06F 17/278; G06F 17/214; G06F 3/0482

(57) ABSTRACT

An information processing device according to one aspect of the present invention comprises: input means whereby a first named-entity classification is inputted for a second character string within a first character string; and display means whereby information about an estimated second named-entity classification for a third character string different from the second character string is displayed on the basis of the first named-entity classification. The information about the second named-entity classification may be a visual attribute that corresponds to the second named-entity classification.

### CROSS-REFERENCE TO RELATED APPLICATIONS

This application is based upon and claims priority under 35 U.S.C. §119 to Japanese Patent Application No. 2016-139740, filed on Jul. 14, 2016, entitled “Information Processing Device, Program, and Information Processing Method,” the entire contents of which are hereby incorporated herein by reference.

### FIELD

The technology disclosed in the present application relates to an information processing device for executing information processing that relates to an interface for named-entity classification.

### BACKGROUND

Various language processing technologies have been developed in recent years for causing a computer to process a natural language. Natural languages are configured from a plurality of characters, terms, etc., and therefore it is necessary to perform analyses of morphemes, syntax, context, meaning, etc., in natural language processing. Because a large amount of named entities are included in natural languages, technologies for classifying or extracting named entities in such analyses have been proposed, such as in Japanese Patent Application laid-open Publication No. 2010-128774 (patent document 1) or Japanese Patent Application laid-open Publication No. 2015-176355 (patent document 2), each of which is hereby incorporated herein by reference in its entirety.

### SUMMARY

Various embodiments of the present invention provide an information processing device, program, and method which readily support classification of named entities by a user.

An information processing device according to one aspect of the present invention comprises: input means whereby a first named-entity classification is inputted for a second character string within a first character string; and display means whereby information about an estimated second named-entity classification for a third character string different from the second character string is displayed on the basis of the first named-entity classification. The character strings may be terms, kanji compounds, expressions, or sentences.

In the information processing device according to one aspect of the present invention, the information about the second named-entity classification may be a visual attribute that corresponds to the second named-entity classification. The visual attribute that corresponds to the second named-entity classification displays not only the name of the second named-entity classification, but also color, size, shading, pattern, typeface, design, etc.

In the information processing device according to one aspect of the present invention, a part of the first character string, which is a target for which the first named-entity classification can be inputted, and a part of a fourth character string, which is a target for which the information about the second named-entity classification can be displayed, may comprise the same characters displayed in different locations.

In the information processing device according to one aspect of the present invention, a part of the first character string, which is a target for which the first named-entity classification can be inputted, may be a target for which the information about the second named-entity classification can be displayed.

In the information processing device according to one aspect of the present invention, a display device may be provided whereby the information about the second named-entity classification is displayed using a visual attribute in the first character string, for which the first named-entity classification can be inputted.

An information processing device according to one aspect of the present invention comprises display means whereby a visual attribute that corresponds to a named-entity classification pertaining to a third character string within a fourth character string is displayed for the third character string.

In the information processing device according to one aspect of the present invention, the visual attribute may be at least one of color, size, shading, pattern, typeface, or design.

An information processing device according to one aspect of the present invention comprises: display control means whereby a plurality of alternatives for named-entity classifications are displayed for a second character string within a first character string; and selection means whereby one of the plurality of alternatives can be selected.

In the information processing device according to one aspect of the present invention, the input means or the selection means may be capable of inputting or selecting the second character string by a mouse, a touch panel, or a pen-type device.

A program according to one aspect of the present invention causes a computer to operate as: input means whereby a first named-entity classification is inputted for a second character string within a first character string; and display means whereby information about an estimated second named-entity classification for a third character string different from the second character string is displayed on the basis of the first named-entity classification.

In the program according to one aspect of the present invention, the computer may be caused to operate as display means whereby the information about the second named-entity classification is displayed using a visual attribute in the first character string, for which the first named-entity classification can be inputted.

A program according to one aspect of the present invention causes a computer to operate as display means whereby a visual attribute that corresponds to a named-entity classification pertaining to a second character string within a first character string is displayed for the second character string.

A program according to one aspect of the present invention causes a computer to operate as: display means whereby a plurality of alternatives for named-entity classifications are displayed for a second character string within a first character string; and selection means whereby one of the plurality of alternatives can be selected.

A method according to one aspect of the present invention includes: a step for inputting, via input means, a first named-entity classification for a second character string within a first character string; and a step for displaying, on the basis of the first named-entity classification, information about an estimated second named-entity classification for a third character string different from the second character string.

In the method according to one aspect of the present invention, a step may furthermore be included whereby information about the second named-entity classification is displayed, via display means, using a visual attribute in the first character string, for which the first named-entity classification can be inputted.

A method according to one aspect of the present invention comprises displaying a visual attribute that corresponds to a named-entity classification pertaining to a second character string within a first character string, via display means, for the second character string.

A method according to one aspect of the present invention includes: a step whereby a plurality of alternatives for named-entity classifications are displayed, via display means, for a second character string within a first character string; and a step whereby one of the plurality of alternatives is selected via selection means.

The embodiments of the present invention make it possible to improve convenience for users.

### BRIEF DESCRIPTION OF THE DRAWINGS

FIG. 1 is a block diagram showing the configuration of an information processing system that includes an information processing device according to one embodiment of the present invention;

FIG. 2 is a block diagram showing the configuration of an information processing system that includes an information processing device according to another embodiment of the present invention;

FIG. 3 is a block diagram showing the functional configuration of the information processing system that includes the information processing device according to one embodiment of the present invention;

FIG. 4 shows alternatives for named-entity classification managed by the information processing system that includes the information processing device according to one embodiment of the present invention;

FIG. 5 shows a situation in which one of the alternatives for named-entity classification managed by the information processing system that includes the information processing device according to one embodiment of the present invention has been selected;

FIG. 6 shows other alternatives for named-entity classification managed by the information processing system that includes the information processing device according to one embodiment of the present invention;

FIG. 7 shows terms managed by the information processing system that includes the information processing device according to one embodiment of the present invention, and named-entity classifications that correspond to the aforementioned terms;

FIG. 8 is a diagram showing input/output relationships of a determination unit for performing machine learning managed by the information processing system that includes the information processing device according to one embodiment of the present invention;

FIG. 9 is one flow chart showing a specific example of an operation performed by the information processing system that includes the information processing device according to one embodiment of the present invention;

FIG. 10 is one flow chart showing a specific example of an operation performed by the information processing system that includes the information processing device according to one embodiment of the present invention;

FIG. 11 is one flow chart showing a specific example of an operation performed by the information processing system that includes the information processing device according to one embodiment of the present invention;

FIG. 12 is one example of a screen image displayed by the information processing system that includes the information processing device according to one embodiment of the present invention;

FIG. 13 is one example of a screen image displayed by the information processing system that includes the information processing device according to one embodiment of the present invention;

FIG. 14 is one example of a screen image displayed by the information processing system that includes the information processing device according to one embodiment of the present invention;

FIG. 15 is one example of a screen image displayed by the information processing system that includes the information processing device according to one embodiment of the present invention;

FIG. 16 is one example of a display relating to named-entity classification displayed by the information processing system that includes the information processing device according to one embodiment of the present invention; and

FIG. 17 is one example of a reference base relating to named-entity classification constructed by the information processing system that includes the information processing device according to one embodiment of the present invention.

### DETAILED DESCRIPTION

Various embodiments of the present invention are described below with reference to the drawings. Constituent elements that are the same across multiple drawings have the same reference numbers attached thereto.

1. Configurations of Information Processing Device

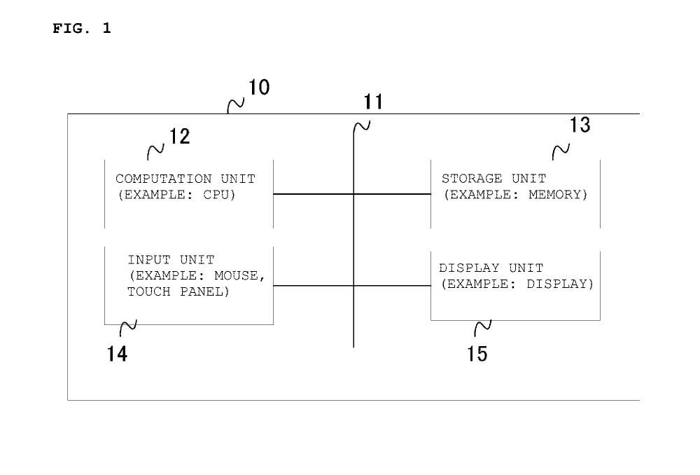

An information processing device 10, when in a system that does not include a network, can have a bus 11, a computation unit 12, a storage unit 13, an input unit 14, and a display unit 15, as shown in FIG. 1.

The bus 11 has a function whereby information is conveyed between the computation unit 12, the storage unit 13, the input unit 14, and the display unit 15.

An example of the computation unit 12 is a processor. The computation unit 12 may be a CPU or an MPU, and may have a graphics processing unit, a digital signal processor, etc. Essentially, the computation unit 12 should have a function whereby it is possible to execute program commands

The storage unit 13 has a function whereby information is recorded. The storage unit 13 may be either an external memory or an internal memory, and may be either a main storage device or an auxiliary storage device. The storage unit 13 may be a magnetic disk (hard disk), an optical disk, a magnetic tape, a semiconductor memory, etc. The storage unit may be a storage device connected via a network, a cloud-based storage device, etc. There are cases where a register, an L1 cache, an L2 cache, etc., for storing information in a location close to a computation device are included in the computation unit 12 in the schematic diagram of FIG. 1 from the standpoint of not being connected via a bus; however, the storage unit 13, as a device for recording information in the design of computer architecture, may include these units. Essentially, the computation unit 12, the storage unit 13, and the bus 11 should be capable of executing information processing in a coordinated manner.

The case described above involves the computation unit 12 executing an information process on the basis of a program provided in the storage unit 13; however, as an example of a scheme in which the bus 11, the computation unit 12, and the storage unit 13 are combined, the information process pertaining to this system may be realized by a programmable logic device that is capable of changing the hardware circuit, or by a dedicated circuit in which the information processing to be executed has been determined.

The input unit 14 has a function whereby information is inputted. Examples of the input unit 14 include a mouse, a touch panel, a pen-type indication unit, and other such indication units.

The display unit 15 is, e.g., a display. The display unit 15 may be a liquid crystal display, a plasma display, an organic electroluminescent display, etc. Essentially, the display unit 15 should be capable of displaying information. The display unit 15 may also be provided as part of the input unit 14, as in the case of a touch panel.

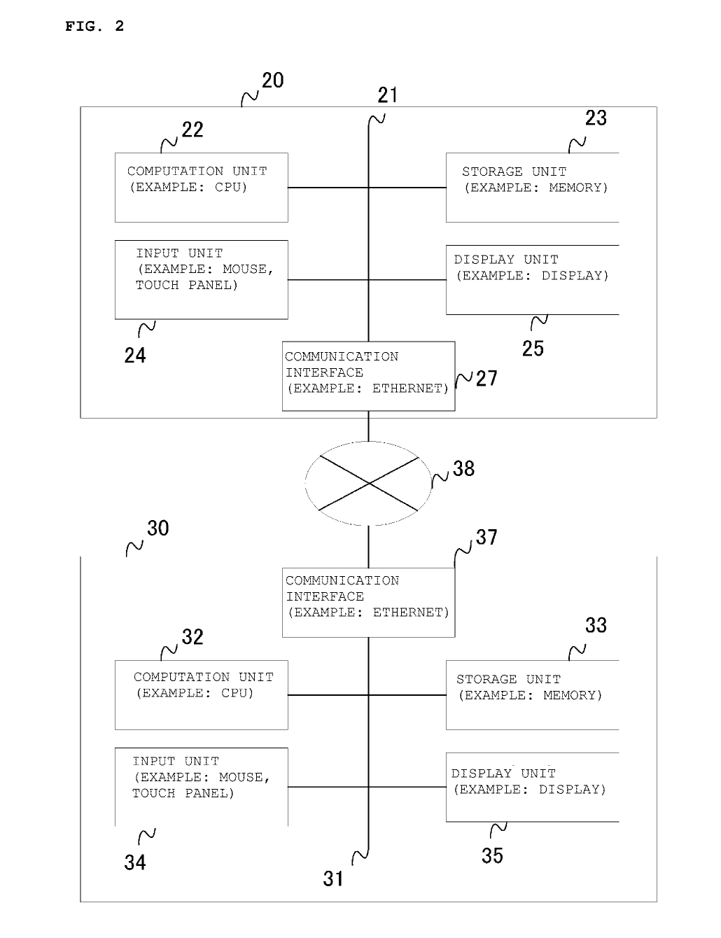

The information processing device of the present application may include a network. An information processing device 20 having a client-server-format network can be configured such that a terminal 20 comprises a bus 21, a computation unit 22, a storage unit 23, an input unit 24, a display unit 25, and a communication interface 27, and such that a server 30 similarly comprises a bus 31, a computation unit 32, a storage unit 33, an input unit 34, a display unit 35, and a communication interface 37, as shown in FIG. 2.

The hardware devices of the terminal 20 and server 30 can be considered to be similar to the hardware devices of the information processing device 10. Specifically, the buses 21 and 31 correspond to the bus 11, the computation units 22 and 32 correspond to the computation unit 12, the storage units 23 and 33 correspond to the storage unit 13, the input units 24 and 34 correspond to the input unit 14, and the display units 25 and 35 correspond to the display unit 15.

A network 38 has a function whereby information is conveyed between the communication interfaces 27 and 37. Specifically, the network 38 has a function whereby it is possible to convey information from within the terminal 20, which is an information processing device, or from within the server 30 to another information processing device via a network. The communication interfaces 27 and 37 may employ either serial connection or parallel connection, and may employ USB, IEEE 1394, Ethernet (registered trademark), PCI, SCSI, etc. The network 38 may be either wired or wireless, and may use optical fibers, coaxial cables, Ethernet cables, etc.

Furthermore, in addition to a client-server system, a P2P system, grid system, cloud system, etc. can similarly be considered for the information processing system 20.

In one aspect of the invention according to the present application, any of the various hardware systems described above can be applied, provided that the hardware system is capable of realizing any of the software-like functions described below.

2. Units in Information Processing Device, and Functions Thereof

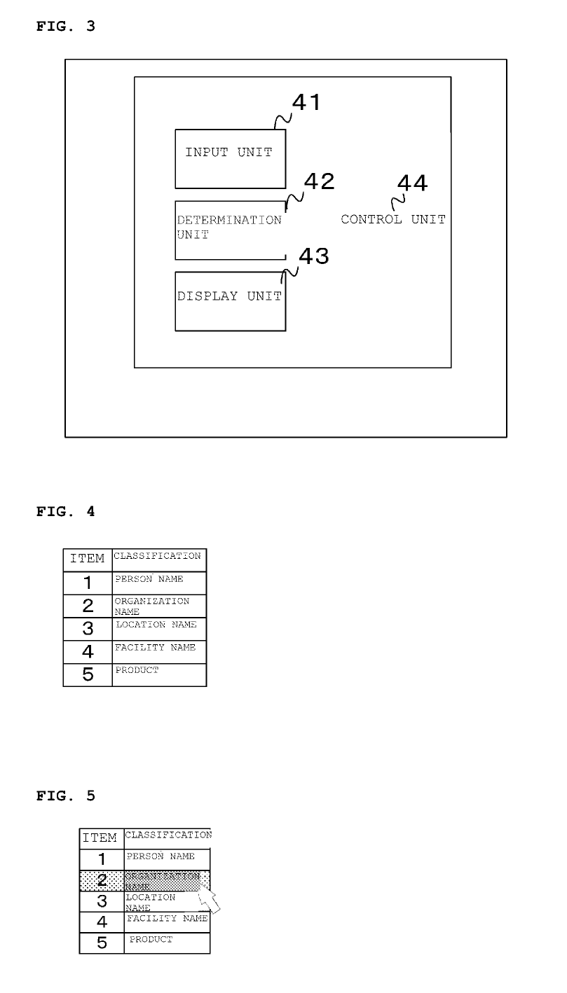

A system according to one aspect of an information processing device in which the information-processing-device hardware described above is used has an input unit 41, a determination unit 42, a display unit 43, and a control unit 44, as shown in FIG. 3.

2-1. Input Unit 41

The input unit 41 has a function whereby the system acquires information relating to character strings from within the character strings. However, the input unit 41 may, as an interface with a user, also have a function whereby information for supporting input is displayed.

In the present application document, the primary examples of character strings to be inputted are terms; however, the character strings to be inputted may comprise kanji compounds, expressions, sentences, or any other character string that is to be subjected to natural language processing, instead of terms.

Information relating to terms acquired by the input unit 41 is, specifically, information about the terms and about the classification of the terms as named entities.

In the input unit 41, a term may be directly specified, a term may be directly inputted, or information designating the position of a term in a character string may be acquired. Essentially, it should be possible to specify a term by the acquisition of information specifying the term.

In the input unit 41, information specifying a term may be acquired by the term being specified by an indication device (e.g., a mouse, a touch panel, or a pen-type information specification device; the input unit 41 not being limited to these examples, provided that a method for specifying a term on a display device is available).

When a term is directly inputted, the input unit 41 may acquire information specifying the term by the characters that constitute the term being specified by a keyboard, a mouse, or another character-specifying means.

Furthermore, the input unit 41 may acquire information specifying the term by the position of the term in a character string being specified by a numerical value.

A character string includes one or a plurality of elements constituting a part of language. A term is the smallest unit that can be extracted as a named entity or classified as a named entity. Some terms are configured from a single character, such as the Japanese syllabic character “ka” (which can mean “mosquito”) or “hi” (which can mean “fire”); other terms are configured from a plurality of characters.

There are cases where the linguistic meaning of a term specified by the methods described above is generally unclear. For example, there are cases when a character string that has fewer characters than does a term is selected. One example is the case in which the Japanese character string “gakko,” which appears within the Japanese term “gakkou” (which can mean “school”), is selected. In this case, the selected character string “gakko” may be managed as a target (as a term) and processed. Specifically, the character string may be managed such that information about a named-entity classification pertaining to the term “gakko” is inputted. This is because it is possible for there to be cases where a user assigns a named-entity classification to such a neologism. Aside from that, in the above example, there may be a function whereby a selection of whether the selected term is “gakko” or the estimated character string “gakkou” can be inputted by the function of a separate control unit. When a user makes a mistake in a character string for which a named entity is to be inputted, this function allows the user to select a typical term as a candidate.

Named-entity classification is the classification of named entities. In Message Understanding Conferences (MUCs; evaluation-type projects for information extraction), classification is limited to seven types (organization name, person name, location name, date expression, time expression, money expression, and percentage expression), and in the Information Retrieval and Extraction Exercise (IREX), an additional eighth type (artifact name) was employed; however, in the present application document, named entities are not limited to these types. A user can freely set classification items in this system in accordance with the purpose of extracting named entities, and can also freely set the number of classifications. Reducing the number of classifications makes it possible to execute processing of subtle natural language with fine granularity. However, setting an increased number of classifications presents an advantage in that it is possible to reduce the load on a user inputting information that relates to the classifications.

Information about a named-entity classification relating to a term can be inputted using various methods. For example, information indicating classification names may be directly inputted, and may be in a format selected from a plurality of alternatives. Essentially, information about a named-entity classification relating to a term should be able to be inputted.

When a named-entity classification relating to a term is selected from a plurality of alternatives, the input unit 41 may acquire information relating to the classification on the basis of classification information specified by an indication device (e.g., a mouse, a touch panel, or a pen-type information specification device; the input unit 41 not being limited to these examples, provided that a method for specifying a named-entity classification on a display device is available).

FIG. 4 shows an example of named-entity classification. In the example in FIG. 4, there are five classifications: “person name,” “organization name,” “location name,” “facility name,” and “product.” The classifications are stored by, e.g., a storage unit (storage unit 13, 23, 33, etc.) within a control unit. The classifications may be stored in the storage unit in advance. The classifications may be constructed upon receipt of a setting from a user during use of this system. This system may be configured such that alternatives for named-entity classifications such as are shown in FIG. 4 are displayed in correspondence with selected terms.

Information about a classification pertaining to a term may be selected from among classifications and inputted by an indication device. For example, in the example shown in FIG. 5, the second item, “organization name,” is selected.

The number of classifications may be increased or reduced before or during use of this system. A function may be provided such that, when the number of classifications is reduced, a setting is made indicating whether deleted classifications are to be absorbed into another classification or eliminated. The classification name of a classification may be changed before or during use of this system. The method of classification may be changed during use of this system. When there is a relationship (e.g., an inclusive relationship) between classifications, this relationship does not affect the real core of the classification.

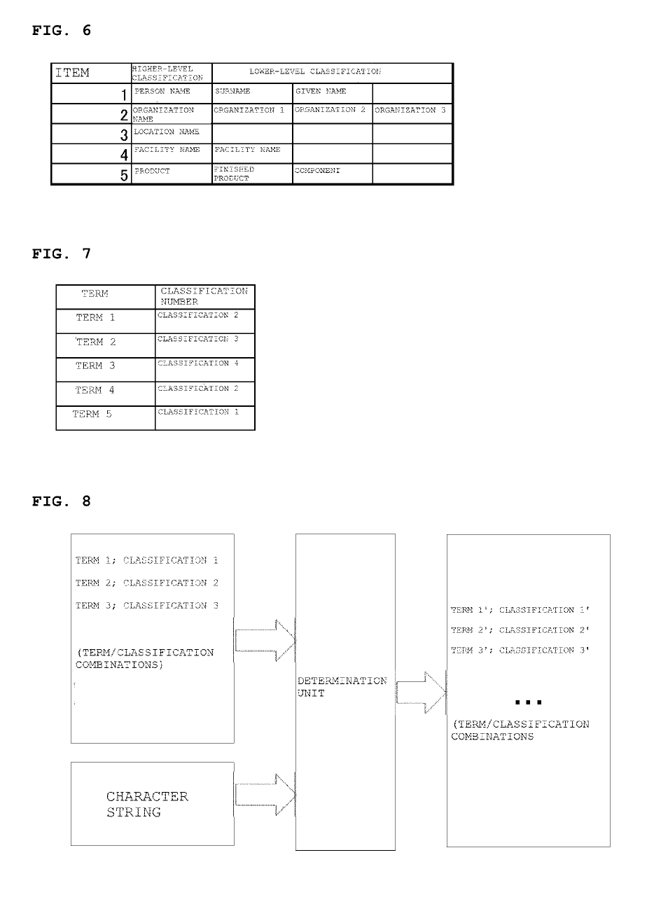

Named-entity classifications for terms may be organized in hierarchical levels. For example, there may be a higher-level classification and corresponding lower-level classifications, such as a higher-level classification of “person name” and lower-level classifications of “surname” and “given name,” as shown in FIG. 6.

In the case of the information processing device 10, the input unit 41 is realized using at least any one of the bus 11, the computation unit 12, the storage unit 13, the input unit 14, and the display unit 15, and in the case of the information processing devices 20 and 30, the input unit 41 is realized using at least any one of the bus 21, the computation unit 22, the storage unit 23, the input unit 24, the display unit 25, the bus 31, the computation unit 32, the storage unit 33, the input unit 34, the display unit 35, the communication interface 27, the communication interface 37, and the network 38.

2-2. Determination Unit 42 The determination unit 42 has a function whereby, from a provided term/classification combination, a combination of a term within a character string other than the aforementioned term and a classification is derived (estimated). This function can be realized by machine learning. The system of machine learning that is used may be well-known. Examples include neural networks that include deep learning, functional logic programming, support vector machines, genetic programming, and Bayesian networks. Any system of machine learning will have a function whereby a database relating to named-entity classification of terms in the prior art is used to determine a named-entity classification for a term included within a provided character string. However, databases relating to named-entity classification are typically insufficient; therefore, there are cases where it is impossible to determine named-entity classifications for all terms in a provided character string. Accordingly, there are cases where information about terms and corresponding classifications are newly provided and learned, whereby it is possible to obtain new terms and corresponding classifications in a provided character string.

FIG. 8 shows the input/output relationships of the determination unit 42. Inputs to the determination unit 42 include character strings and term/classification combinations. A term/classification combination comprises a combination of a term within a character string and information about a named-entity classification provided for the term by a user. There may be a plurality of term/classification combinations. However, there are cases where the determination means does not perform any learning from the user-provided information, and the new term and corresponding classification relating to the character string are not displayed.

Examples of term/classification combinations that serve as inputs to the determination unit 42 are given in the list in FIG. 7. In FIG. 7, classifications 1 through 4 are assigned to terms 1 through 5. Examples of term/classification combinations that serve as outputs from the determination unit 42 could be given in a list similar to that in FIG. 7; in such a case, classifications 1 through 4 would be derived (estimated) for different terms (e.g., terms 6 through 15) from the terms (terms 1 through 5) shown in FIG. 7.

In the case of the information processing device 10, the determination unit 42 is realized using at least any one of the bus 11, the computation unit 12, and the storage unit 13, and in the case of the information processing devices 20 and 30, the determination unit 42 is realized using at least any one of the bus 21, the computation unit 22, the storage unit 23, the bus 31, the computation unit 32, the storage unit 33, the communication interface 27, the communication interface 37, and the network 38.

2-3. Display Unit 43

The display unit 43 has a function whereby not only is a character string displayed, but also a classification for a term displayed within the character string is displayed on the basis of information about the term and corresponding classification outputted by the determination unit 42. The state of the display can include at least one of color, size, shading, pattern, typeface, design, etc.

Normally there are a plurality of classifications. Displaying classifications for terms makes it possible for a user to recognize classifications (e.g., whether a classification for a given term is “location name,” “person name,” or “product”) for the terms.

In the case of the information processing device 10, the display unit 43 is realized using at least any one of the bus 11, the computation unit 12, the storage unit 13, and the display unit 15, and in the case of the information processing devices 20 and 30, the display unit 43 is realized using at least any one of the bus 21, the computation unit 22, the storage unit 23, the display unit 25, the bus 31, the computation unit 32, the storage unit 33, the display unit 35, the communication interface 27, the communication interface 37, and the network 38.

2-4. Control Unit 44

The control unit 44 controls the overall and specific operations of the input unit 41, the determination unit 42, and the display unit 43. In the case of the information processing device 10, the control unit 44 is realized using at least any one of the bus 11, the computation unit 12, the storage unit 13, the input unit 14, and the display unit 15, and in the case of the information processing devices 20 and 30, the control unit 44 is realized using at least any one of the bus 21, the computation unit 22, the storage unit 23, the input unit 24, the display unit 25, the bus 31, the computation unit 32, the storage unit 33, the input unit 34, the display unit 35, the communication interface 27, the communication interface 37, and the network 38.

3. Operation

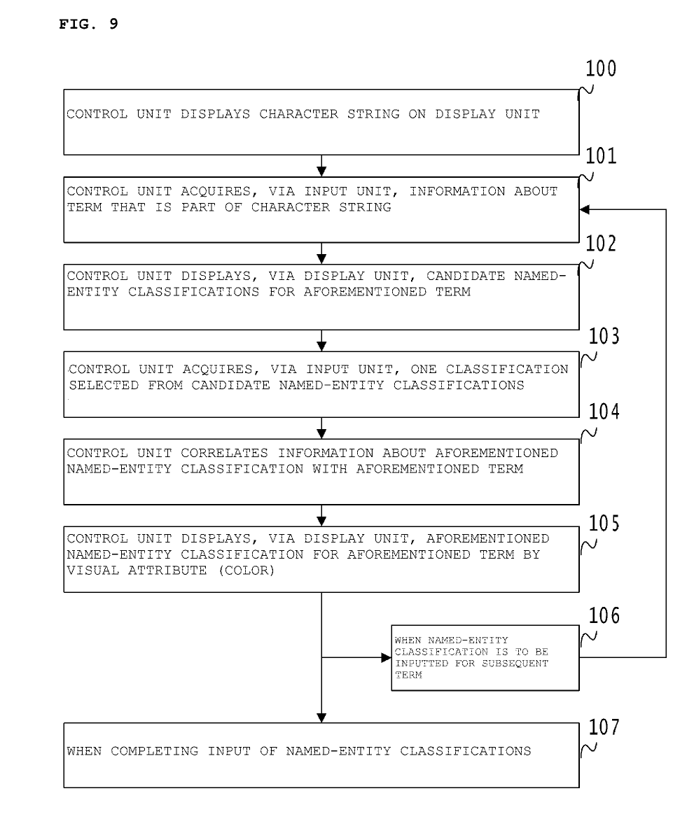

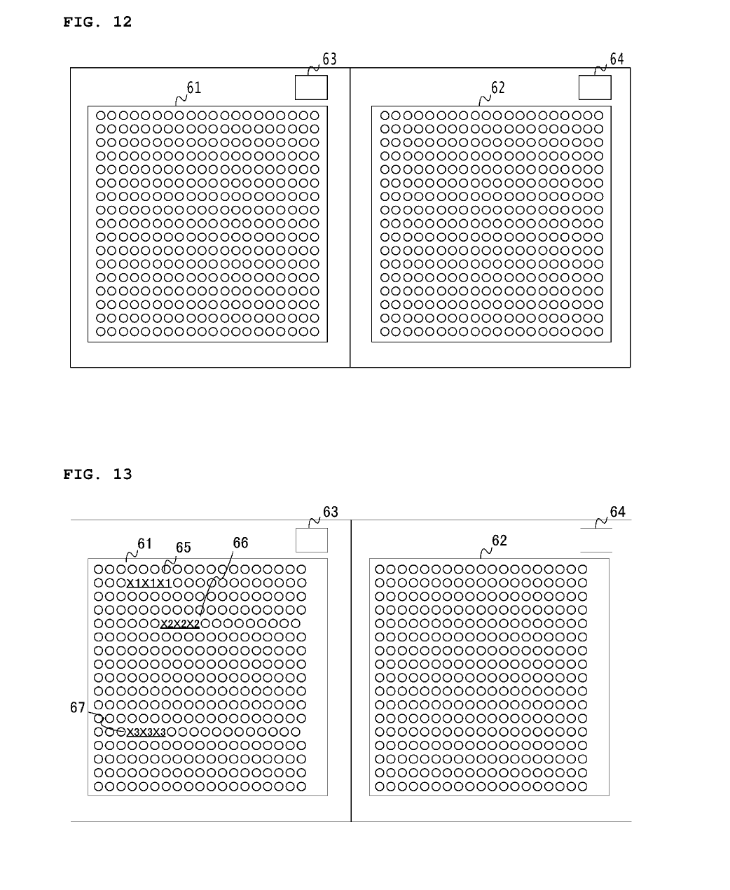

The operation of the device according to one embodiment of the present invention is described below with reference to the interfaces shown as examples in FIG. 12-15 and the flow diagrams shown as examples in FIG. 9-11.

In FIG. 12, a display unit 43 relating to an information processing device according to one embodiment of the present invention comprises a user input unit 61 with which information pertaining to a term can be inputted, a classification display unit 62 with which a named-entity classification pertaining to the term can be displayed, a machine learning initiation switch 63 with which it is possible to indicate that machine learning is to be performed, and a display switch 64 with which it is possible to indicate that information about a named-entity classification displayed after learning is to be displayed (reflected) on the user input unit 61.

In step 100 (“step” being abbreviated below as “ST”) shown in FIG. 9, the control unit 44 displays a character string on the display unit 43 (e.g., the user input unit 61 in FIG. 12). If no user has provided information, this character string may include one or a plurality of terms for which no named-entity classification can be derived.

In FIG. 12, the string of “◯”s presented within the user input unit 61 represents a character string. In FIG. 12, the character string displayed by the user input unit 61 for inputting a named-entity classification for a first term is the same as the character string displayed within the classification display unit 62 with which it is possible to display, in relation to a second term different from the first term, the second term and a corresponding named-entity classification derived by machine learning, etc. Therefore, a user can provide information about a classification for a term within the character string presented by the user input unit 61 while making a visual comparison with the classification display unit 62. In particular, as described later, an advantage is presented in that when a classification obtained by machine learning is incorrect, because the user input unit 61 and the classification display unit 62 have the same character string, the user can easily provide a classification that the user considers to be correct for the term for which the incorrect classification was provided, within the user input unit 61 at a location that corresponds to the incorrect named-entity classification.

In ST101, the control unit 44 acquires, via the input unit 41, information about a term that is a part of the character string. A term that is a part of the character string displayed by the display unit 43 may be specified by a user using, e.g., a mouse as an indication device to select the term.

This term may be a term that typically has a linguistic meaning, or may be a term that typically does not have a linguistic meaning. This is because, although there are cases where a user intends to specify a term that has a linguistic meaning, there are also cases where the user intends to specify a term that is used with a special meaning.

Thus, according to one aspect of this system, which is configured such that a user can select a term to be subjected to machine learning from within a sentence in which multiple terms are present while comparing and referring to the entire character string, machine learning and derivation of named-entity classifications can be efficiently performed, therefore reducing the load on the user. Specifically, although the selection of terms to be learned includes terms for which classifications from other terms in the character string are readily derived by machine learning, the selection also includes terms for which this is not the case. In the case of this system with which it is possible to select terms for which classifications from other terms in the character string are readily derived, the classifications from the other terms can readily be derived automatically by this system, therefore making it possible to further the reduction in the load on the user. The choice of which terms within the character string should have a classification thereof taught in the machine learning depends on the type of character string being managed and the system of machine learning being used; however, selecting, e.g., a frequently used term facilitates the automatic classification of other frequently used terms, thus furthering the reduction of the load on the user.

In ST102, the control unit 44 displays, via the display unit 43, a named-entity classification for the term. This display may be performed on the basis of information about named-entity classifications that is prepared in the storage unit in advance. When the term specified in ST101 is unclear, a step for confirming the definition of the term may be carried out prior to ST102. For example, a list of meaning-bearing candidate terms other than the specified term may be displayed using another database, etc. In such a case, the user can select the designated term for which a named-entity classification is actually intended to be inputted.

In ST103, the control unit 44 acquires, via the input unit 41, one classification selected from candidates for the named-entity classification. Thus, according to one aspect of this system, which is configured such that a named-entity classification that corresponds to the term within the character string can be selected from among candidates, a named-entity classification for the term can easily be inputted to the system, therefore reducing the load on the user. This advantage is effective even when no classification can be newly provided by the machine learning system being used.

In ST104, the control unit 44 correlates the term and the selected named-entity classification. Information about the term and the selected named-entity classification may be registered, as a term/classification combination, in a table in the storage unit (storage unit 13, 23, or 33). The term/classification combination may also form part of a reference base of named-entity classifications for the document that includes the character string.

In ST105, the control unit 44 differentiates and displays, via the display unit 43, the named-entity classification for the term. This makes it possible for the user to ascertain that the system has recognized the input of the classification for the term.

For example, in FIG. 13, the classification for a term 65 (X1X1X1) is represented via the color of the term 65 or the color of the background of the term 65 (colors not shown). In the present embodiment, the term 65 is represented by X1X1X1; i.e., by three characters (six characters) (the same applies to other terms 66, etc.). However, the terms are in no way intended to be limited to a length of three characters (six characters); as shall be apparent, there is no limitation on the number of characters in a term.

The state or visual attribute for differentiating and displaying the named-entity classification can include at least one of color, shading, size, pattern, typeface, design, etc.

The state or visual attribute for differentiating and displaying the named-entity classification may also be represented using a state in which the aforementioned color, shading, size, pattern, typeface, design, etc., are mixed. For example, classifications 1 through 3 may be represented by different colors, classification 4 may be represented by a different typeface, and classification 5 may be represented by a different pattern. In particular, in cases where classification is performed at a plurality of hierarchical levels, when the classifications are represented using a mix of the above, making the representation formats uniform for each of the levels makes it possible to perform classification in an easily understood manner.

In cases where a named-entity classification is represented by a state or visual attribute for differentiating and displaying as described above, it is possible to avoid increasing the quantity of text in a target document, as happens when the name of the named-entity classification is added to the text; therefore, the named-entity classification in the target document is easier to understand. This advantage is effective even when no classification can be newly provided by the machine learning system being used.

When “color” is used as a method for differentiating and representing the named-entity classifications, the classifications for each of the terms can be differentiated by displaying each of the classifications in a different “color.” In this case, the “color” may be “color” that is applied to the characters of the terms, “color” that is applied to the background of the characters of the terms, “color” that is applied to a frame surrounding the characters, “color” that is applied to an area fill covering the characters, “color” that is applied to an underline drawn under the characters, or “color” that is applied to an overline drawn above the characters. Essentially, a term positioned within a character string should be specified, and be differentiated by “color” in a state that is correlated to the term (a state that cannot be mistaken as corresponding to another term). “Color” presents an advantage in making it possible to readily represent a plurality of classifications in mutually different ways.

When “shading” is used as a method for differentiating and representing the named-entity classifications, the classifications for each of the terms can be differentiated by displaying each of the classifications with a different “shading.” In this case, the “shading” may be “shading” that is applied to the characters of the terms, “shading” that is applied to the background of the characters of the terms, “shading” that is applied to a frame surrounding the characters, “shading” that is applied to an area fill covering the characters, “shading” that is applied to an underline drawn under the characters, or “shading” that is applied to an overline drawn above the characters. Essentially, a term positioned within a character string should be specified, and be differentiated by “thickness” in a state that is correlated to the term (a state that cannot be mistaken as corresponding to another term). “Shading” presents an advantage in making it possible to readily represent a plurality of classifications in mutually different ways in cases where color printing is unavailable for the character strings to which classification is applied.

When “size” is used as a method for differentiating and representing the named-entity classifications, the classifications for each of the terms can be differentiated by displaying each of the classifications in a different “size.” In this case, the “size” of the characters of the terms may be changed, or the “size” of a frame surrounding the characters may be changed. Essentially, a term positioned within a character string should be specified, and be differentiated by “size” in a state that is correlated to the term (a state that cannot be mistaken as corresponding to another term).

When a “pattern” is used as a method for differentiating and representing the named-entity classifications, the classifications for each of the terms can be differentiated by displaying each of the classifications in a different “pattern.” In this case, the “pattern” may be a “pattern” that is applied to the characters of the terms, a “pattern” that is applied to the background of the characters of the terms, a “pattern” that is applied to a frame surrounding the characters, a “pattern” that is applied to an area fill covering the characters, a “pattern” that is applied to an underline drawn under the characters, or a “pattern” that is applied to an overline drawn above the characters. Essentially, a term positioned within a character string should be specified, and be differentiated by a “pattern” in a state that is correlated to the term (a state that cannot be mistaken as corresponding to another term). Similarly to “shading,” “pattern” presents an advantage in making it possible to readily represent a plurality of classifications in mutually different ways in cases where color printing is unavailable for the character strings to which classification is applied.

When “typeface” is used as a method for differentiating and representing the named-entity classifications, the classifications for each of the terms can be differentiated by displaying each of the classifications in a different “typeface.”

When “design” is used as a method for differentiating and representing the named-entity classifications, the classifications for each of the terms can be differentiated by displaying each of the classifications in a different “design”. In this case, the “design” may be a “design” that is applied to the characters of the terms, a “design” that is applied to the background of the characters of the terms, a “design” that is applied to a frame surrounding the characters, a “design” that is applied to an area fill covering the characters, a “design” that is applied to an underline drawn under the characters, or a “design” that is applied to an overline drawn above the characters. Essentially, a term positioned within a character string should be specified, and be differentiated by a “design” in a state that is correlated to the term (a state that cannot be mistaken as corresponding to another term).

A table indicating the correlative relationship between the classification names and each of the methods for representing the classifications, such as is shown in FIG. 16, may be displayed so as to make it easier to understand specifically which classifications are indicated by the various representation methods.

In ST106 of FIG. 9, a subsequent named-entity classification for a term is indicated, in which case the process flow returns to ST101. Information about classifications for the term 66 (X2X2X2) and the term 67 (X3X3X3) shown in FIG. 13 is thereby added and represented.

ST107, however, indicates a case where the input of subsequent named-entity classifications is completed. This temporarily ends input, after which machine learning is performed; however, named-entity classifications may be inputted again thereafter.

Enabling this process flow to be executed multiple times makes it possible to repeatedly carry out processes, e.g.: first providing information about classifications for some of the terms in a character string for which classification for many of the terms cannot be performed by conventional machine learning systems; checking the character string, which can be estimated by machine learning due to the provision of information; providing information about classifications for the terms again if classification is still insufficient; estimating the classifications by machine learning; etc. This repeatability makes it possible to promptly derive classifications of terms in a character string while reducing the input load on a user, while the user observes the state of progress of the machine learning.

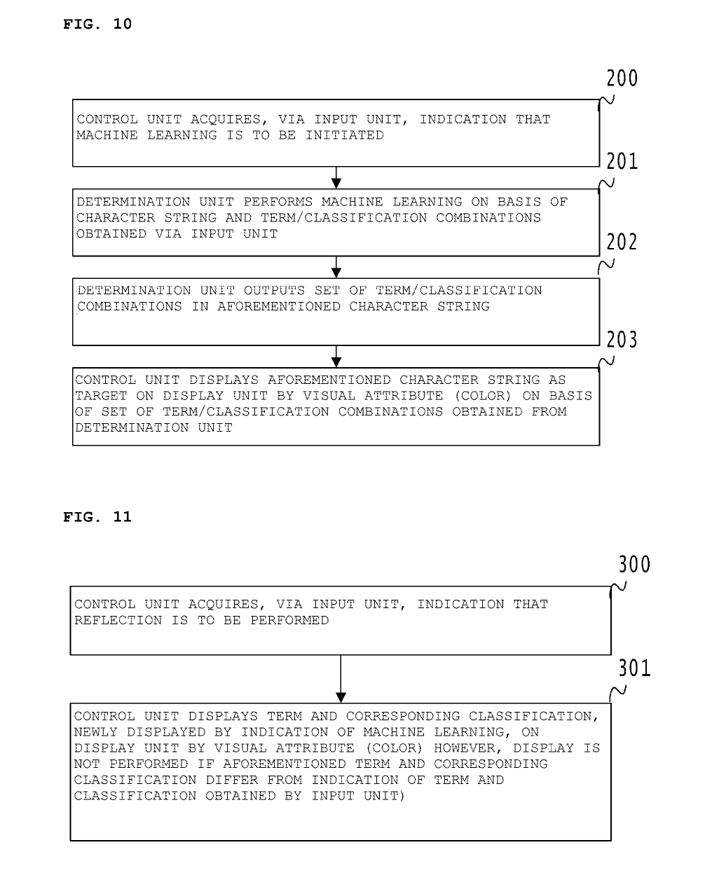

The process flow by which the system performs machine learning on the basis of inputted information is described below with reference to FIG. 10.

First, in ST200, the control unit 44 acquires, via the input unit 41, an indication that machine learning is to be initiated. In FIG. 13, the machine learning initiation switch 63 is provided, the switch being used to initiate machine learning.

In ST201 of FIG. 10, the determination unit 42 executes machine learning on the basis of a character string and a set of term/classification combinations obtained via the input unit 41.

In ST202, the determination unit 42 outputs a set of term/classification combinations in the character string. Information about the term/classification combinations may be registered in the storage unit (storage unit 13, 23, or 33). The term/classification combinations may also form part of a reference base of named-entity classifications for the document that includes the character string.

There may also be cases where no new term/classification combinations can be outputted by machine learning, depending on the inputted terms and corresponding classifications.

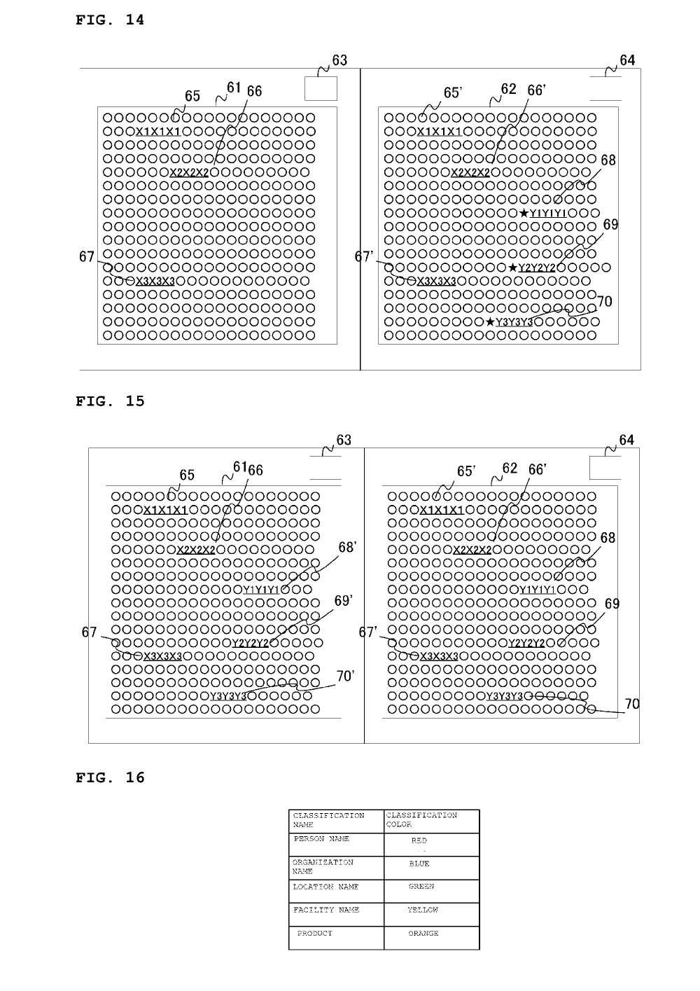

In ST203, the control unit 44 displays, via the display unit 43, the character string as a target on the basis of the term/classification combinations obtained from the determination unit 42. For example, in FIG. 14, the term 65, the term 66, and the term 67, each of which comprises a term and a corresponding classification provided by a user, are shown by the classification display unit 62 as a term 65′, a term 66′, and a term 67′. In FIG. 14, a term 68, a term 69, and a term 70 are newly derived by machine learning from the input of the classifications of the term 65, the term 66, and the term 67. The classifications of the term 68, the term 69, and the term 70 are displayed by the classification display unit 62. In FIG. 14, the classification of the term 68 (Y1Y1Y1) is represented by the color of the term 68 and the color of the background of the term 68 (colors not shown).

In the representation described above, similarly to the display of named-entity classifications in the user input unit 61, the state or visual attribute for displaying the named-entity classification can include at least one of color, shading, size, pattern, typeface, design, etc. The states or visual attributes have the same configuration as is described above, and therefore no description thereof is given.

A fixed display may be performed for terms for which a classification is newly derived by machine learning. One example includes the application of a “★” mark in front of terms for which classification is newly derived by machine learning. A user would thereby understand (when realizing machine learning and inference, especially multiple times) that a term for which a “★” mark or other fixed display is performed is a term for which a named-entity classification has been newly added by the most recent machine learning.

Because terms having the “★” mark are terms for which a classification has been automatically derived by machine learning, the effort required for a user to input classifications for these terms is mitigated if the classification is correct.

The “★” mark is provided by way of an example. However, a “Δ” mark, a “□” mark, or any other mark may be used instead of a “★” mark.

The process flow by which the result of machine learning is reflected (displayed) is described below with reference to FIG. 11.

First, in ST300, the control unit 44 acquires, via the input unit 41, an indication that reflection (display) is to be performed. In FIG. 15, the display switch 64 is displayed.

In ST301 of FIG. 11, the control unit 44 displays the terms and corresponding classifications derived by machine learning on the user input unit 61.

In FIG. 15, the term 68, the term 69, and the term 70, which are terms for which classifications were obtained by machine learning, are displayed on the user input unit 61 as a term 68′, a term 69′, and a term 70′.

The “★” mark applied in front of the term 68, the term 69, and the term 70 may be deleted using the display switch 64.

Because the display of the term 68′, the term 69′, and the term 70′ performed by the user input unit 61 as described above is also a display of named-entity classifications in the user input unit 61, the state or visual attribute for displaying the named-entity classification can include at least one of color, shading, size, pattern, typeface, design, etc. The states or visual attributes have the same configuration as is described above, and therefore no description thereof is given.

A configuration may be adopted such that, in cases where any of the classifications for the term 68, the term 69, and the term 70 obtained by machine learning is an undesirable classification from the standpoint of the user (cases where machine learning outputs an incorrect result; e.g., a case where the classification for the term 69 is incorrect), when a correct classification (a classification different from the classification obtained by machine learning in the classification display unit 62) is inputted for the term 69′ within the user input unit 61 before the display switch 64 is pushed, the classification inputted by the user is prioritized and the information about the classification for the term 69 in the classification display unit 62 is not reflected (displayed) for the term 69′ within the user input unit 61. This makes it possible to perform the display such that a classification inputted by the user is prioritized over an incorrect result of machine learning.

Causing the named-entity classification derived by machine learning to be displayed (reflected) by the user input unit 61 in this manner makes it possible to efficiently provide information about named-entity classifications for a character string that includes multiple unknown terms and reduce the load on the user.

The following is one example in which a specific expression is used to reduce the load on the user. The Japanese terms “machikado shouyu ramen” and “moyashi miso ramen” were present within a provided text. No named-entity classification was able to be derived for either of the terms using the database provided for machine learning. At this point, a user provided information about the classification of “product name” for the term “machikado shouyu ramen,” and this information was subjected to machine learning. As a result of this machine learning, the classification of “product name” was able to be automatically derived for the term “moyashi miso ramen” within the text. When using one aspect of this system, the user first provides information about the classification of “product name” for the term “machikado shouyu ramen” within the user input unit 61. At this time, a visual attribute indicating the classification of “product name” is shown for the term “machikado shouyu ramen” within the user input unit 61. For example, a red color is applied as the color of the background of the term “machikado shouyu ramen” within the user input unit 61, where the color of the background of the term is the aforementioned visual attribute, and the red color is the visual attribute indicating the classification of “product name.” Next, the machine learning initiation switch 63 is pushed, whereby the red color is displayed as the color of the background of the term “moyashi miso ramen” within the classification display unit 62 as a visual attribute indicating that “product name” is the classification of the term “moyashi miso ramen.” The user, considering that this derivation is correct, pushes the display switch 64 without making any revisions, whereby the red color is displayed as the color of the background of the term “moyashi miso ramen” within the user input unit 61 as a visual attribute indicating that “product name” is the classification of the term “moyashi miso ramen” within the user input unit 61. In this manner, the need for the user to input information about the named-entity classification of “product name” for the term “moyashi miso ramen” is obviated, and the load on the user is reduced.

This example is now described using the term 65 (the term 65′) and the term 68 (the term 68′) shown in FIG. 15. In the above example, the term 65 (the term 65′) corresponds to “machikado shouyu ramen,” and the term 68 (the term 68′) corresponds to “moyashi miso ramen.” Specifically, machine learning is performed using information about the term “machikado shouyu ramen,” which is the term 65 (the term 65′), and the classification of “product name,” which corresponds to this term. Due to this machine learning, the classification of “product name” is derived (estimated) for the term “moyashi miso ramen,” which corresponds to the term 68 (the term 68′) and for which no classification could be derived (estimated) before the information was provided.

The method for representing a classification displayed for a term in the user input unit 61 in ST105 of FIG. 9 and the method for representing a classification displayed for a term in the classification display unit 62 in ST203 of FIG. 10 may be different, even if these methods are of the same type (or follow the same rule). In cases where the method for representing a classification displayed for a term in the user input unit 61 and the method for representing a classification displayed for a term in the classification display unit 62 are the same, and particularly in the case of a screen image whereby the user can view both the user input unit 61 and the classification display unit 62 at the same time as shown in FIG. 12-15, displaying the classifications by the same representation method presents an advantage in that the classifications are easy to understand. However, even if the method for representing a classification displayed for a term in the user input unit 61 and the method for representing a classification displayed for a term in the classification display unit 62 are different, the classifications for the terms should be able to be ascertained; therefore, it is not essential for these representation methods to be the same.

In the embodiment described above, the user input unit 61 and the classification display unit 62 were displayed adjacent to each other on the left and right sides of a single screen, respectively. However, as shall be apparent, the user input unit 61 and the classification display unit 62 may instead be displayed in the opposite configuration. Alternatively, the user input unit 61 and the classification display unit 62 may be displayed on the top and bottom sides of a single screen, respectively, or may be displayed in the opposite configuration. Essentially, when the user input unit 61 and the classification display unit 62 are provided in positions such that both the user input unit 61 and the classification display unit 62 can be viewed at the same time, a user can input, revise, or confirm information about named-entity classifications while comparing the user input unit 61 and the classification display unit 62, as described above.

However, instead of being disposed within a single window, a screen of the user input unit 61 and a screen of the classification display unit 62 may be disposed in separate windows and be displayed by switching of the display. In this case, an advantage is presented in that executing the input and the display of the result of machine learning on the same screen reduces the space required for use, and therefore even a mobile telephone, smartphone, console, touch pad, reader, or other information processing device having a small display screen can be used without inconvenience. As shall be apparent, information processing devices having a large display screen present an advantage in that multiple character strings can be viewed at once even when input and display are executed on the same screen; therefore, it is axiomatic that such actions can be executed on other information processing devices.

In this case, an interface according to this system may have a switching switch for switching whether the user input unit 61 or the classification display unit 62 is being displayed.

Furthermore, the user input unit 61 and the classification display unit 62 may be configured as a single input/output unit. For example, a configuration may be adopted in which after a user has inputted a named-entity classification for a term in a character string, using the machine learning initiation switch 63 appropriately initiates machine learning for the same character string, and when information about a named-entity classification for a new term in the character string is obtained as a result of the machine learning, the information is displayed by the input/output unit. In this case, a “★” mark such as is described above may be applied in front of the term pertaining to the newly added named-entity classification. This makes it possible for a user to newly specify a term pertaining to the named-entity classification. A configuration may be adopted in which, when the named-entity classification obtained by machine learning and the named-entity classification considered by the user are different, information about the named-entity classification that the user considers to be correct for the term pertaining to the different classifications can be inputted for the aforementioned term within the input/output unit, which is the same as the user input unit 61 and the classification display unit 62.

A character string to which information about a classification of a term obtained by this system has been applied can be used by another natural-language processing system, etc., as a named entity in the text that includes the character string, or can also be used in a reference base of named-entity classifications for another text that is similar to the text that includes the character string.

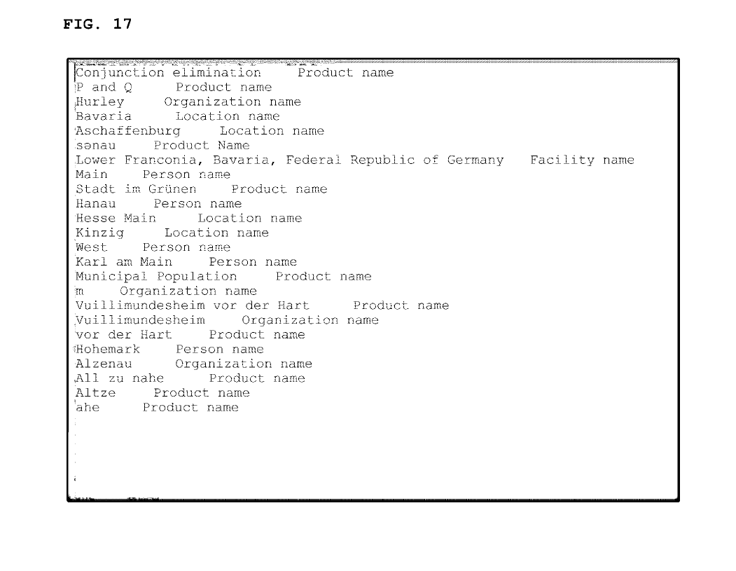

FIG. 17 shows one example of the aforementioned reference base. In this example, a reference base of named-entity classifications for terms (character strings) is created using this system. The target to which named-entity classifications are provided in this system is a character string; as described above, the character strings are not limited to being terms, but rather may be kanji compounds, expressions, or sentences. Therefore, in the example of FIG. 17, the named-entity classification “product name” is provided for the character string “conjunction elimination.” The named-entity classification “product name” is also provided for the character string “P and Q.” Furthermore, the classification “product name” may be provided for the expression “municipal population,” which includes a blank space in the Japanese, and the named-entity classifications “person name” and “organization name” may be provided, respectively, to the character strings “west” and “m,” which comprise single characters in the Japanese. As shall be apparent from this drawing, named-entity classifications can be provided for character strings from various languages without being language-dependent. Such a reference base can be created as a result of applying this system; however, this system can also be configured such that no such reference base is created.

There are a variety of situations in which this system can be used. For example, a case in which an expression used in a text has a special usage within a specific group is conceivable. A representative example of this situation is a neologism or an abbreviation. Even beyond neologisms and abbreviations, there are cases where, e.g., a special expression is used for a department name or project name in a specific industry. Such special expressions see wide use only within the specific group. Therefore, it is difficult to extract named entities using a typical named-entity reference base when dealing with a text in which these special expressions are used. There are cases where at least these neologisms, abbreviations, or special expressions cannot appropriately be extracted as named entities or classified as such. However, when the one embodiment of the present invention is applied, information about appropriate named-entity classifications can easily be applied by a user for special expressions, therefore making it possible to easily perform named-entity classification even for texts in which such special expressions are used.

The processes and procedures described in this specification can be realized not only by the means explicitly described in this embodiment, but also by software, hardware, or a combination of these. The processes and procedures described in this specification can be installed as a computer program and can be executed by a variety of computers.

### REFERENCE NUMBERS

10 Information processing device
11 Bus
12 Computation unit
13 Storage unit
14 Input unit
15 Display unit
20 Information processing unit
21 Bus
22 Computation unit
23 Storage unit
24 Input unit
25 Display unit
27 Communication interface
30 Information processing unit
31 Bus
32 Computation unit
33 Storage unit
34 Input unit
35 Display unit
37 Communication interface
38 Network
41 Input unit
42 Determination unit
43 Display unit
44 Control unit
61 User input unit
62 Classification display unit
63 Machine learning initiation switch
64 Display switch
65-70, 65′-70′ Term

What is claimed is:

1. An information processing device, having
a memory including program commands; and
a processor configured to execute the program commands,
characterized by comprising:
an input unit whereby a first named-entity classification is inputted for a second character string within a first character string;
a determination unit whereby, from a provided term/classification combination including the second character string/the first named-entity classification combination, a combination of a third character string different from the second character string and the corresponding the estimated second named-entity classification is derived based on a machine learning; and
a display unit whereby information about the estimated second named-entity classification for the third character string is displayed.

2. The information processing device as recited in claim 1, characterized in that the information about the second named-entity classification is a visual attribute that corresponds to the second named-entity classification.

3. The information processing device as recited in claim 1, characterized in that a part of the first character string, which is a target for which the first named-entity classification can be inputted, and a part of a fourth character string, which is a target for which the information about the second named-entity classification can be displayed, comprise the same characters displayed in different locations.

4. The information processing device as recited in claim 1, characterized in that a part of the first character string, which is a target for which the first named-entity classification can be inputted, is a target for which the information about the second named-entity classification can be displayed.

5. The information processing device as recited in claim 1, characterized by comprising
a display unit whereby the information about the second named-entity classification is displayed using a visual attribute in the first character string, for which the first named-entity classification can be inputted.

6. The information processing device as recited in claim 2, characterized in that the visual attribute is at least one of color, size, shading, pattern, typeface, or design.

7. The information processing device as recited in claim 1, characterized by comprising:
a display control unit whereby a plurality of alternatives for named-entity classifications are displayed for the second character string within the first character string; and
selection means whereby one of the plurality of alternatives can be selected.

8. The information processing device as recited in claim 1, characterized in that the input unit or a selection means is capable of inputting or selecting the second character string by a mouse, a touch panel, or a pen-type device.

9. A non-transitory computer readable medium storing a program, characterized by causing a computer to operate as:
an input unit whereby a first named-entity classification is inputted for a second character string within a first character string; and
a display unit whereby information about an estimated second named-entity classification for a third character string different from the second character string is displayed on the basis of the first named-entity classification.

10. The non-transitory computer readable medium storing a program as recited in claim 9, characterized by causing the computer to operate as:
a display unit whereby the information about the second named-entity classification is displayed using a visual attribute in the first character string, for which the first named-entity classification can be inputted.

11. The non-transitory computer readable medium storing a program as recited in claim 9, characterized in that a part of the first character string, which is a target for which the first named-entity classification can be inputted, and a part of a fourth character string, which is a target for which the information about the second named-entity classification can be displayed, comprise the same characters displayed in different locations.

12. The non-transitory computer readable medium storing a program as recited in claim 9, characterized in that a part of the first character string, which is a target for which the first named-entity classification can be inputted, is a target for which the information about the second named-entity classification can be displayed.

13. The non-transitory computer readable medium storing a program as recited in claim 9, characterized by comprising:
a display unit whereby the information about the second named-entity classification is displayed using a visual attribute in the first character string, for which the first named-entity classification can be inputted.

14. The non-transitory computer readable medium storing a program as recited in claim 9, characterized by causing the computer to operate as:
a display unit whereby a plurality of alternatives for named-entity classifications are displayed for the second character string within the first character string; and
selection means whereby one of the plurality of alternatives can be selected.

15. A method including:
a step for inputting, via an input unit, a first named-entity classification for a second character string within a first character string; and
a step for displaying, on the basis of the first named-entity classification, information about an estimated second named-entity classification for a third character string different from the second character string.

16. The method as recited in claim 15, furthermore including:
a step whereby information about the second named-entity classification is displayed, via a display unit, using a visual attribute in the first character string, for which the first named-entity classification can be inputted.

17. The method as recited in claim 15, characterized in that a part of the first character string, which is a target for which the first named-entity classification can be inputted, and a part of a fourth character string, which is a target for which the information about the second named-entity classification can be displayed, comprise the same characters displayed in different locations.

18. The method as recited in claim 15, characterized in that a part of the first character string, which is a target for which the first named-entity classification can be inputted, is a target for which the information about the second named-entity classification can be displayed.

19. The method as recited in claim 15, characterized by comprising:
a step whereby the information about the second named-entity classification is displayed using a visual attribute in the first character string, for which the first named-entity classification can be inputted.

20. The method as recited in claim 15, characterized by comprising:
a step whereby a plurality of alternatives for named-entity classifications are displayed, via a display unit, for a second character string within a first character string; and
a step whereby one of the plurality of alternatives is selected via selection means.
